(19) United States
(12) Patent Application Publication
(10) Pub. No.: US 2020/0359615 A1
(43) Pub. Date: Nov. 19, 2020

(54) Boat & Pier Fishing Reel Holder

(71) Applicant: Author Reed, Miami Gardens, FL (US)

(72) Inventor: Author Reed, Miami Gardens, FL (US)

(21) Appl. No.: 16/416,156

(22) Filed: May 18, 2019

(51) Int. Cl. A01K 97/10

(52) U.S. Cl. CPC A01K 97/10

(57) ABSTRACT

A rod and reel holder for use on fishing piers which is configured to be easily mountable by clipping onto a vertical surface of an object with slits on the sides, tethered bolts/knobs, and one side that hinges open to slip over the pier. The base can be changed to fit (1) a boat, or (2) a pier and there is an adjustable “red light” at the tip for night time visibility.

### BACKGROUND

### Field of the Invention

The present invention generally relates to fishing equipment and fishing related accessories, more specifically relates to a portable device for holding and supporting fishing reels or rods.

### Description of the Related Art

Fishermen or people who indulge in fishing activity are typically required to carry out numerous other activities during fishing. These activities include, for example, baiting a hook, replacing or changing a lure, untangling the fishing line, removing a hook from a caught fish, releasing a fish, steering a boat, etc. Typically, these activities require the fisherman to hold the rod or reel in position while performing such activities. However, it is often difficult to hold the rod or reel at a convenient angle in one hand while carrying out the aforementioned activities using the other hand.

Numerous fishing rod or reel holders exists in the art; these holders typically require a specific type of rod or reel for setting up tip downs and comprises a clamp or screw type mounting mechanism. Fishing rod or reels are required to be mounted on different types of vertical surfaces including boat wall, pail, pier and the like. Therefore, there is a need in the art for fishing rod or reel holders with a common mounting mechanism, which allows the holder to be mounted on different surfaces as discussed above.

Another limitation with the existing fishing rod or reel holders is lack of strong holding of the fishing rod or reel, especially during situations when a powerful strike by a fish will pull the entire fishing rod or reel into the water which results in loss of expensive fishing equipment. For example, during ice fishing, a fisherman will occasionally leave an ice fishing hole unattended with the result that a powerful strike by a fish will pull the entire fishing rod or reel into and through the hole so that the fishing rod or reel is lost. Similarly, during open water fishing unattended fishing rod or reel lying on a pier or extending from a boat may get pulled into the water body by the fish.

However, to Applicant's knowledge, none of these prior art methods have been found to be completely suitable to meet these needs and are cumbersome. Thus, there is a need in the prior art to Holds user fish rod or reel while he is pier fishing. The present invention provides such a device and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment the present invention is a holder for fish rod or reel while user is pier fishing.

Embodiments of the invention relates, to a flexible device that is adjustable, there are slits on the sides, with tethered bolts/knobs, and one side that hinges open to slip over the pier.

Another embodiment of the invention is, to provide an improved rod or reel holder which is readily adjustable in any desired angular disposition relative to the mounting surface.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 is a side perspective view.

FIG. 200 shows a closer view of the clamping screw.

FIG. 300 is a side view of the device for holding a fishing rod or reel.

FIG. 400 is a front view of our Invention.

FIG. 500 is a perspective view of our Invention.

FIG. 600 is a top side view of our Invention

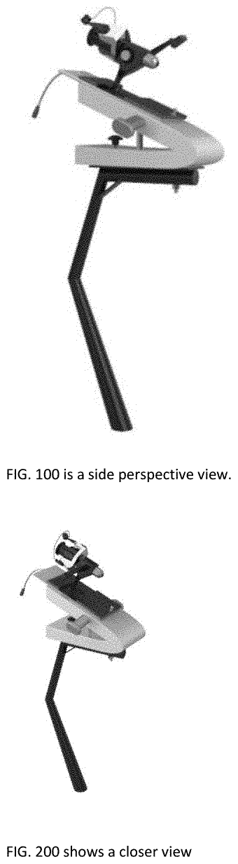

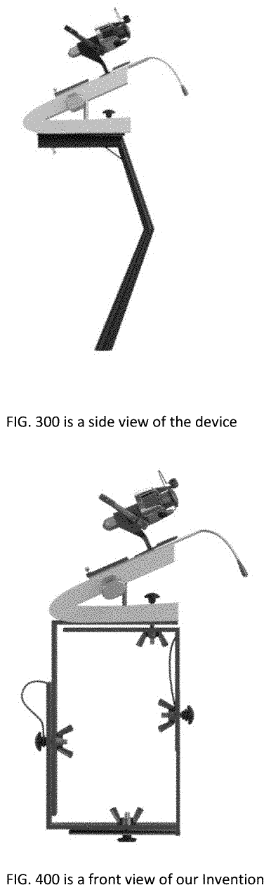

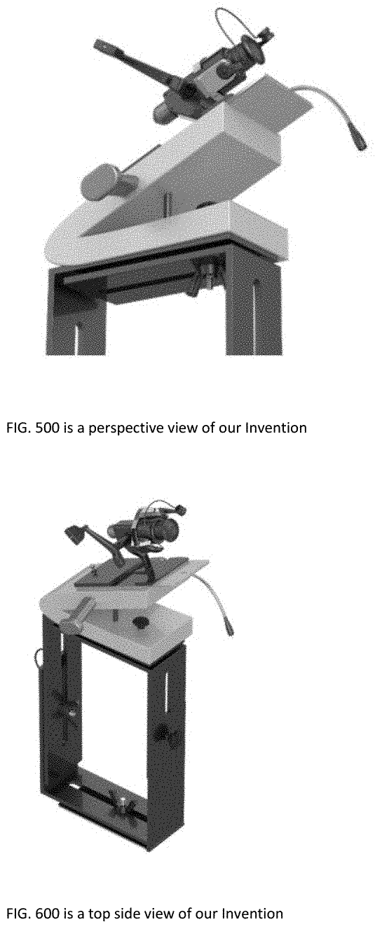

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

The present invention is an improvement over prior art which discloses a device for holding a fishing rod or reel. The fishing rod or reel holding device is configured to easily mountable by clipping onto a vertical surface of an object. The device is adjustable; there are slits on the sides, with tethered bolts/knobs, and one side that hinges open to slip over the pier.

One of the numerous advantages of the present invention is the device that can be used with any fishing rod or reel and does not require users to buy a specific rod or reel type. The device for holding fishing rod or reel requires no preliminary mounting using screws or clamps; the device can be easily clipped onto any vertical surface. The device is easily portable, made of metal or plastic and may further comprise predetermined rod or reel settings suitable for different fishing conditions.

It is yet a further object of the present invention to provide an improved rod or reel holder for anglers which is readily adjustable in any desired angular disposition relative to the mounting surface.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A device for holding a fishing rod or reel, the device comprising:
The device of claim 1, is adjustable, there are slits on the sides, with tethered bolts/knobs, and one side that hinges open to slip over the pier.
The device of claim 1 is made of plastic or metal.
